(19) United States
(12) Patent Application Publication
(10) Pub. No.: US 2010/0297442 A1
(43) Pub. Date: Nov. 25, 2010

(54) METHOD AND DEVICE FOR PRODUCING A MULTI-COLORED COMPOSITE THREAD

(75) Inventors: Stefan Kalies, Hoffeld (DE); Friedrich Lennemann, Neumunster (DE)

Correspondence Address: BAINWOOD HUANG & ASSOCIATES LLC, 2 CONNECTOR ROAD, WESTBOROUGH, MA, 01581, US

(73) Assignee: OERLIKON TEXTILE GMBH & CO. KG, Remscheid (DE)

(21) Appl. No.: 12/738,895

(22) PCT Filed: Oct. 8, 2008
(86) PCT No.: PCT/EP08/63437

§ 371 Date: Aug. 3, 2010

(30) Foreign Application Priority Data
Oct. 23, 2007 (DE) 10 2007 050 551.7

(51) Int. Cl. B29C 47/30; B32B 1/00

(52) U.S. Cl. 428/373; 264/172.14; 425/464; 425/162

(57) ABSTRACT

The invention relates to a method and a device for producing a multi-colored composite thread made of a plurality of extruded colored filament bundles. To this end, a plurality of different dyed polymer melts is generated and extruded in parallel through a plurality of spinnerets to form the colored filament bundles. The colored filament bundles are brought together as a mixed color to form the composite thread. In order to generate a color pattern or to correct the mixed color of the composite thread, according to the invention, the generation of the dyed polymer melts is modified during the extrusion of the filament bundle in order to modify the mixed color of the composite thread.

The invention relates to a method for the production of a multi-color composite thread according to the generic part of claim 1, and a device for carrying out the method according to the generic part of claim 10.

A method according to the generic part, and a device according to the generic part are known from EP 1 035 238 A1.

In the known method and the known device initially multiple dyed polymer melts are produced parallel next to each other for the production of a multi-color composite thread, and extruded through a plurality of separate spinnerets to form a colored filament bundle. The filament bundles are comprised of a plurality of individual filament strands that are extruded to form continuous strands. Subsequent to multiple treatment steps of cooling and stretching the colored filament bundles are brought together to form a composite thread. The composite thread is therefore imparted a mixed color, which is achieved by bringing together the colored filaments of the individual filament bundles.

Such multi-color composite threads are utilized in particular with the production of BCF threads, wherein particularly the mixed color of the composite thread determines the visual appearance of the carpet. Depending on the mixed color of the composite thread, different color patterns in the carpet fiber. Therefore, in practice it is desirable to combine the colored filament bundles to a desired mixed color of the composite thread in a manner as flexible as possible.

For this purpose the number of filament bundles that are combined to a composite thread may be modified in the known methods and the known device. For example, two or three-color filament bundles may be combined to a composite thread that has one mixed color.

In this manner, however, variations of the composite thread are created, which differ in the amount of filament bundles.

In order to form a composite thread from multiple colored filament bundles at the same amount of filament bundles, further devices and method are known according to prior art. For example, EP 0485 871 A1 discloses a variation, wherein the filament bundles are twisted separately from each other by additional means before combining the same to composite threads.

A further method is known from DE 42 02 896 A1, wherein a false twist is created in the filament bundles before combining them to the composite thread.

In the device and method known from EP 0 133 198 the filament bundles are continuously changed in their relative position to each other in order to therefore receive another mixing of the filaments to a composite thread before feeding the same to a texturizing agent. For this purpose some of the filament bundles are disposed back and forth at small strokes.

All methods and devices for producing a multi-color composite thread according to prior art have in common that a certain appearance and look of the composite thread, particularly of the mixed color of the composite thread, is to be achieved solely by means of the type of bringing together the filament bundles. However, such methods represent an increasing stress on the filament strands within the filament bundles, which may also have a negative effect on the crimping previously incorporated in the filaments. The changes of the mixed color achieved by means of the mixing of the individual filaments of the filament bundles are also possible to a limited degree as the total amount of the colored filaments remains constant within the composite thread.

A method, wherein the mixed color of the composite thread can be changed by means of changing the amount of the colored filament strands is already known from DE 1 805 954. Accordingly, combinations of colored filament strands may be combined with an individual number of individual filaments. However, this method is extremely elaborate for practical use, as a change in the amount of filament strands within a filament bundle goes along with a change of the spinneret.

The object of the invention is therefore to further improve a method and a device for producing a multi-color composite thread of the generic type such that a mixed color of the composite thread may be adjusted and changed.

Another aim of the invention is to provide a method and a device for producing a multi-color composite thread, wherein the composite thread may be produced having predetermined color effects in the mixed color.

The problem is solved by means of a method having the characteristics according to claim 1 and by means of a device having the characteristics according to claim 10.

Advantageous further improvements of the invention are defined by the characteristics and characteristics combinations of the respective sub-claims.

The invention provides the particular advantage that no additional intervention is necessary for mixing the filaments of the colored filament bundles in order to change the mixed color of the composite thread. In order to change or adjust the mixed color of the composite thread the production of dyed polymer melts is changed according to the invention during the extrusion process of the filament bundles. In this manner it is possible to influence the extrusion of the filament bundles in such a way that the filaments forming the filament bundles are already created having a desired visual appearance in order to achieve the desired mixed color of the composite thread when the remaining filament bundles are brought together.

In order to obtain a composite thread having the same physical properties as much as possible despite of the changed production of the dyed polymer melts and the inherent changes of the extrusion of the filament bundles, the method variation is preferably carried out, wherein the composite thread is determined by means of a total yarn count that is of equal count before and after the changing of the mixed color of the composite thread. This method variation therefore enables an intervention into the melt spinning process for producing the composite thread in order to change only the mixed color, and thus the appearance of the composite thread.

The producing of the dyed polymer melt provided for the extrusion of one of the filament bundles may be carried out according to an advantageous method variation such that the conveying amount of the polymer melt to be extruded is increased or reduced. For example, an increase in the conveying amount of the polymer melt would result in the spinneret having a higher melt output during the extrusion of the filament bundle, thus achieving a higher spinning yarn count of the filament bundle. In this manner the color content determined by the filament bundle is increased overall within the composite thread as opposed to the remaining filament bundles due to the great mass. The color of the filament bundle is therefore more prominent. Despite of the same color concentration within the filaments different color effects may be created in the composite thread by means of changing the melt output and thus the changing of the spinning yarn count of the filaments. Thick and thin filaments generally have a different light reflection. The appearance becomes darker with an increased filament yarn count.

In order to reinforce such coloring effects the method variation is particularly advantageous, wherein a plurality of conveyor amounts of the polymer melts are simultaneously changed in relation to a total conveyor amount of all polymer melt for the extrusion of all filament bundles. In this manner, for example, a polymer melt of a first color can be combined with a greater conveying amount, and a second polymer melt of a second color can be combined with a smaller conveying amount such that the color dominance of the filament bundle being extruded at a larger conveying amount is even greater in the composite thread.

In order to maintain a total yarn count of the composite thread that is as constant as possible with a plurality of filament bundles, the conveying amounts of the polymer melts are changed such that the sum of all conveying amounts equals the total conveying amount. In this manner the filament bundles may be extruded in different spinning yarn counts without falling below or exceeding the total yarn count of the composite thread after bring the same together.

In case the dyeing of the polymer melts is carried out by means of a liquid dye, the method variation is preferably utilized, wherein a feeding in of a liquid dye into at least one of the polymer melts is changed by means of increasing or reducing an amount of the dye. In this manner the degree of dyeing of the polymer melt may be influenced before and during the extrusion in an advantageous manner such that the filament bundle may be directly extruded from a polymer melt having a more prominent dye, or from a polymer melt having less dye.

In this case the mixed color effects may also be improved particularly in that the feeding of a plurality of liquid dyes into a plurality of polymer melts is simultaneously changed by means of increasing or reducing the amount of the dyes.

The method according to the invention is therefore particularly suitable to bring about a mixed color in the composite thread at a process start without having to interrupt the process.

In order to produce carpet fiber the method variation is preferably used, wherein the creation of the polymer melts is repeated changed at a predetermined time interval. In this manner the uniform color patterns can be created in the composite thread, which in turn can be utilized for creating visual special effects in a carpet pattern of a carpet canvas.

As an alternative the method may be operated such that the creation of the polymer melt is determined by a machine setting, wherein the extrusion of the filament bundles is carried out by means of alternating machine settings. For this purpose machine settings may be defined, for example, by means of empiric trials, which lead to certain mixed colors of the composite thread. For example, the pattern of the mixed colors in the composite thread may be predetermined by means of periodically changing the machine settings.

In order to carry out the method according to the invention the device according to the invention has a controller, which is connected to at least one of the means for creating the polymer melt, and which controls the created product for changing the color mixture of the composite thread during the extrusion of the filament bundles.

In order to maintain a total yarn count of the composite thread a further improvement of the device according to the invention provides that the controller has a microprocessor, by means of which at least computer operations may be executed for determining a control signal fed to the created product while maintaining the total yarn count of the composite thread. In this manner the producing of the polymer melt may be changed in a controlled manner and in coordination with the remaining polymer melts.

In order to influence the conveying amount the means for producing the polymer melts include a plurality of spinning pumps that can be driven independently of each other via a plurality of pump drives. For this purpose at least one of the pump drives is coupled to the controller for changing the drive speed of the associated spinning pump. In this manner the conveying amount of the spinning pump may be changed by means of increasing or reducing the drive speed of the spinning pump.

In order to maintain a total conveying amount preferably all pump drives of the spinning pump are mutually connected to the controller such that the increasing of the drive speed of one of the pump drives may be compensated using a respective reducing of the drive speed of one of the other pump drives, or a reducing the drive speed of a plurality of pump drives. The sum of the conveying amounts therefore corresponds to a total conveying amount that remains constant during the extrusion of the filament bundles.

Depending on the type of coloring of the polymer melt the device according to the invention may be further improved such that the means for producing the polymer melts have a plurality of feed units for feeding a plurality of liquid dyes, that the feed units have a plurality of dosing pumps that can be driven via separate dosing drives, and that at least one of the dosing drives is connected to the controller for changing a drive speed of the associated dosing pump. In this manner the coloring of the individual polymer melts may be individually influenced by means of increasing or reducing the addition of the colorant.

In order to obtain a mixed color effect on the composite thread the device according to the invention is preferably operated in the embodiment wherein the controller has at least one control program, by means of which a plurality of machine settings may be set in an alternating manner at the means for producing the polymer melt. In this manner, for example, the spinning pumps may be adjusted up or down between two operating speeds such that each adjustment results in a change of the mixed color of the composite thread.

The method according to the invention and the device according to the invention are generally suitable in order to produce multi-color composite threads from a polyamide material, such as a polyester, polypropylene, or polyamide, or combinations of such materials. In particular, the method and the device are suitable for producing so-called BCF yarns. For this purpose the further improvement of the device according to the invention is utilized, wherein the composite means has at least one crimping unit, by means of which the filament bundles are crimped and brought together to form the composite thread. Such crimped composite threads may be used directly for further processing of a carpet canvas.

As an alternative, however, it is also possible that the composite thread has at least one twisting spinneret by means of which the filament bundles are brought together to form the composite thread. In this case combinations may also be carried out such that both the filament bundles are crimped separately before twisting, and the composite thread is crimped after twisting in a crimping unit. Furthermore, additional treatments of the filament bundles and in the composite thread are also possible before or after bring the same together. Such treatments may be carried out as twisting, stretching, and relaxing.

The method according to the invention is described in further detail below, based on a few example embodiments of the device according to the invention with reference to the attached drawings.

They show:

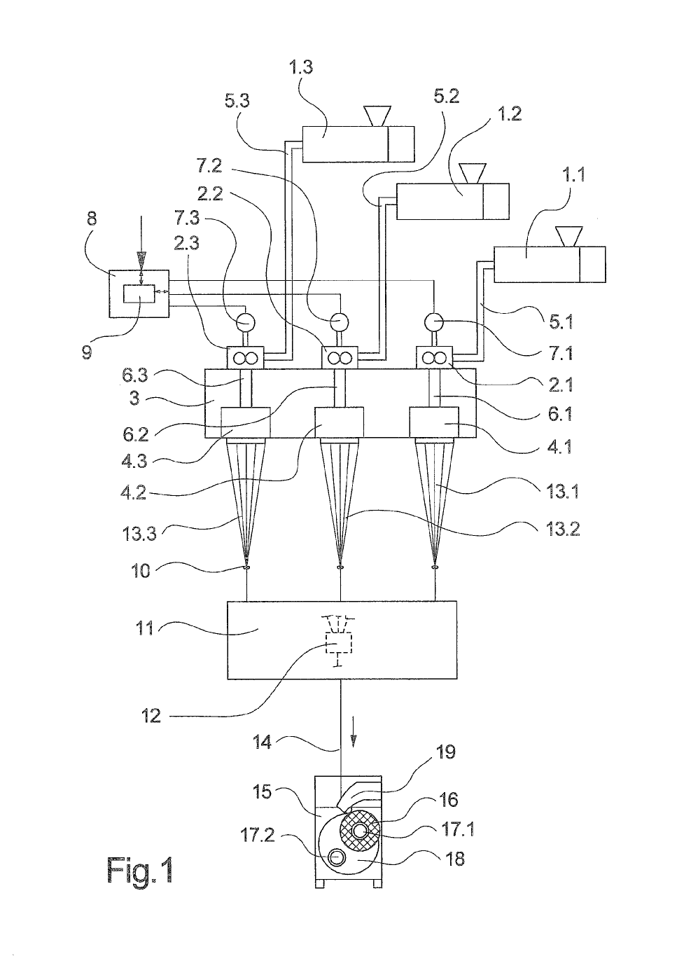

FIG. 1 a schematic view of a first example embodiment of the device according to the invention for carrying out the method according to the invention

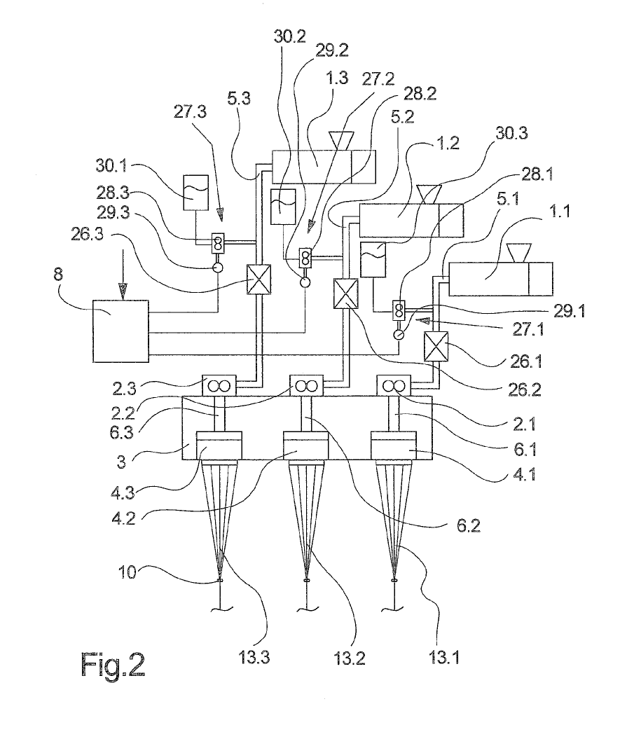

FIG. 2 a schematic view of a further example embodiment of the device according to the invention

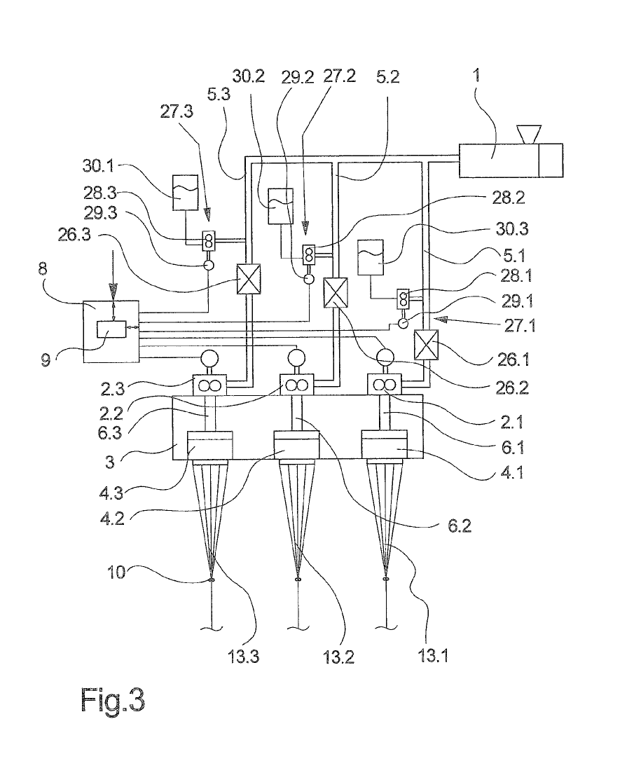

FIG. 3 a schematic further example embodiment of the device according to the invention

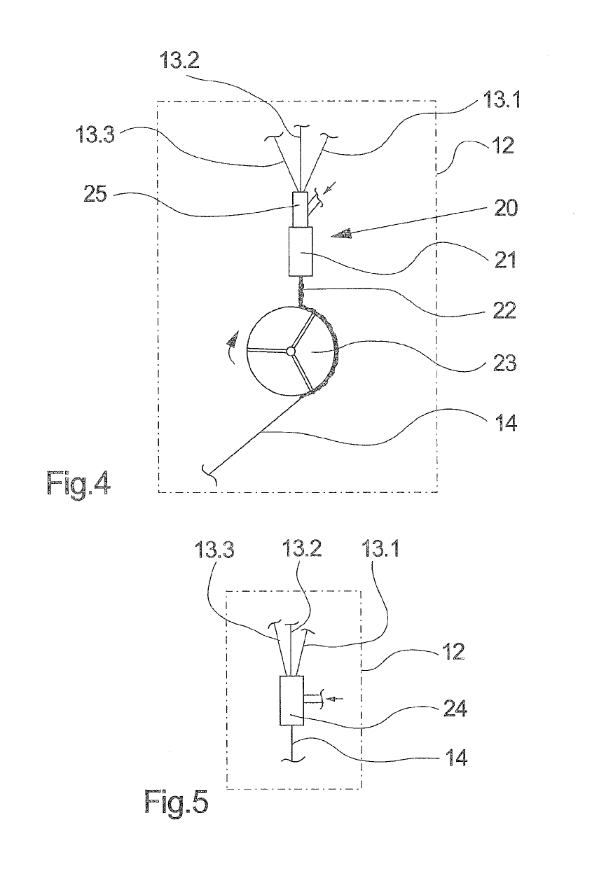

FIG. 4 and

FIG. 5 some schematic example embodiments of a composite means for bringing together a plurality of filament bundles

FIG. 1 shows a first schematic example embodiment of the device according to the invention for carrying out the method according to the invention. For extruding a plurality of colored filament bundles the device has a plurality of spinnerets 4.1, 4.2, and 4.3. The spinnerets 4.1, 4.2, and 4.3 are disposed at a bottom of a heated spinning beam 3. For extruding a plurality of fine filaments, which are guided to the filament bundles 13.1, 13.2, and 13.3, the spinnerets 4.1, 4.2, and 4.3 have nozzle plates at the bottoms thereof, which contain a plurality of nozzle openings. Such spinnerets are generally known, and are therefore not explained in further detail herein.

For the extrusion of the filaments a colored polymer melt is fed to the spinnerets 4.1, 4.2, and 4.3. For this purpose a spinning pump 2.1, 2.2, and 2.3 is associated with each of the spinnerets 4.1, 4.2, and 4.3, which feed the respective polymer melts to the spinnerets 4.1, 4.2, and 4.3 under pressure via the distribution lines 6.1, 6.2, and 6.3. The spinnerets 2.1, 2.2, and 2.3 are disposed next to each other on a top of the spinning beam 3. A separate pump drive is associated with each of the spinnerets 2.1, 2.2, and 2.3. The spinning pump 2.1 is driven by the pump drive 7.1, the spinning pump 2.2 by the pump drive 7.2, and the spinning pump 2.3 by the pump drive 7.3. A controller 8 is provided for controlling the drives, which is coupled to the pump drives 7.1, 7.2, and 7.3. Each of the pump drives 7.1, 7.2, and 7.3 is actuated individually via the controller 8 such that the polymer melt flows created by the spinning pumps 2.1, 2.2, and 2.3 may be fed to the spinnerets 4.1, 4.2, and 4.3 separately and uniformly.

On one inlet side the spinnerets 2.1, 2.2, and 2.3 are each connected to an extruder via a melt line. In this example embodiment a first extruder 1.1 is coupled to the spinning pump 2.1 via the melt line 5.1. Accordingly, a second extruder 1.2 is connected to the spinning pump 2.2 via the melt line 5.2, and the extruder 1.3 is connected to the spinning pump 2.3 via the melt line 5.3. A colored polymer melt is produced in each of the extruders 1.1 to 1.3. For this purpose a granulate of a polymer material as well as additives and colorants may be added to the extruder.

For producing a composite thread the filament bundles 13.1, 13.2, and 13.3 are drawn from the spinnerets 4.1, 4.2, and 4.3 via one thread guide 10 by means of a treatment unit 11 after cooling and bringing the same together. The treatment unit 11 is illustrated symbolically only, since the process units are embodied and individually assembled within the treatment unit 11 depending on the respective type of thread to be produced. In this manner, for example, a stretching may be carried out both on the individual filament bundles and in the composite thread. The treatment unit 11 could therefore comprise the preparation device, stretching devices, twisting devices, relaxing devices, and/or crimping devices. What is essential for the producing of the composite thread 14 in this case, however, is a composite means that brings together the filament bundles 13.1, 13.2, and 13.3 inside of the treatment unit and forms a composite thread 14 having a mixed color from the multi-color filament strands of the filament bundles 13.1, 13.2, and 13.3.

Some example embodiments of the composite means that can be alternatively utilized in the treatment unit 11 are illustrated in FIGS. 4 and 5 for further explanation.

FIG. 4 shows an example embodiment of a composite means 12, as it is used, for example, for producing so-called BCF yarns. For this purpose the composite means 12 is formed by means of a crimping unit 20, which is formed in this example embodiment by a conveyor nozzle 25 and a compression chamber 21. For this purpose the filament bundles 13.1, 13.2, and 13.3 are collectively drawn into a thread channel of the conveyor nozzle 25, and conveyed into a compression chamber 21 by means of a preferably heated fluid. A thread plug 22 is formed in the compression chamber 21 such that the individual filaments of the filament bundles 13.1, 13.2, and 13.3 are deposited and mixed on the surface of the thread plug 22 as loops and arches. The thread plug 22 is compressed, and subsequently cooled via a cooling drum 23, and dissolved to form the crimped composite thread 14. The mixing of the individual filaments of the filament bundles 13.1, 13.2, and 13.3 leads to a mixed color in the now crimped composite thread 14.

As an alternative the filament bundles 13.1, 13.2, and 13.3 may also be brought together with one of the composite means 12 illustrated in the example embodiment shown in FIG. 5. For this purpose the composite means 12 is formed by means of a twisting nozzle 24. Inside of the twisting nozzle 24 an air blast is injected into a thread channel, in which the filament bundles 13.1, 13.2, and 13.3 are guided. In this manner a twisting of the individual filaments and a mixing is created, which results in the composite thread 14.

Depending on the desired type of thread, the treatment unit 11 illustrated in FIG. 1 may be equipped with a composite means 12 according to FIG. 4 or to FIG. 5.

In order to store the composite thread 14 produced, the same is usually wound to form a spool 16. In this manner a winding unit 15 is connected downstream of the treatment unit 11, which has two spool spindles 17.1 and 17.2 held on a spindle carrier 18 in this example embodiment such that the composite thread 14 may be continuously wound to form a spool 16. The winding of the spool 16 is carried out by means of a changing unit 19, which guides the composite thread back and forth along the spool surface such that a cross-wound spool is wound.

For carrying out the method according to the invention the device illustrated in FIG. 1 may be operated in two different ways. In a first variation a colored polymer melt is produced in each of the extruders 1.1, 1.2, and 1.3, wherein the dyed polymer melts differ from each other in terms of their base color. For example, extruder 1.1 could produce a blue dyed polymer melt, extruder 1.2 a yellow dyed polymer melt, and extruder 1.3 a red dyed polymer melt. For this purpose the polymer melts may be produced both from an identical polymer material and from different polymer materials. In order to produce the polymer melts the spinnerets 2.1, 2.2, and 2.3 are initially driven at identical drive speed via the pump drives 7.1, 7.2. In this manner the conveying amounts of the polymer melts produced by the spinnerets 2.1, 2.2, and 2.3 are equally high such that an equal melt output is present at each of the spinnerets 4.1, 4.2, and 4.3 for the extrusion of the filament bundles 13.1, 13.2, and 13.3. The filament bundles 13.1, 13.2, and 13.3 are preferably identical in terms of the number of filaments such that each filament bundle 13.1, 13.2, and 13.3 has an equal spinning yarn count. After bringing the filament bundles together, a total yarn count of the composite thread 14 is therefore achieved. For this purpose the blue dyed filaments of the filament bundle 13.1, the yellow dyed filaments of the filament bundle 13.2, and the red dyed filaments of the filament bundle 13.3 would therefore collectively lead to a mixed color of the composite thread 14.

In case the mixed color does not yet represent the desired appearance of the composite thread 14, the production of the polymer melt is changed. For this purpose a change of at least one drive speed of one of the pump drives 7.1, 7.2, and 7.3 is initiated via the controller 8. For example, the conveying amount of the spinning pump 2.1 could be increased such that a larger amount of blue dyed polymer melt is fed for the extrusion of the spinneret 4.1. For this purpose a higher spinning yarn count is present during the extrusion of the filament bundle 13.1 such that the mass content of the blue dyed filaments is increased overall, and thus the mixed color in the composite thread 14 receives a respectively stronger shade of blue.

However, said method variation is preferably carried out such that with the change of the conveying amount of one of the spinning pumps 2.1, 2.2, and 2.3 no change of the total yarn count of the composite thread 14 occurs, if possible. Therefore, a microprocessor 9 is provided within the controller 8, in which a total conveying amount is stored, which is achieved from the sum of the individual conveying amounts of the three spinning pumps 2.1, 2.2, and 2.3 in order to obtain the total yarn count of the composite thread 14. In case a higher conveying amount needs to be achieved for changing the mixed color of one of the spinning pumps 2.1, 2.2, and 2.3, a respective compensation calculation is carried out via the microprocessor 9 such that a reduction of the conveying amount occurs at least in a different, or in both different spinning pumps. In this manner corresponding control signals may be generated and the pump drives 7.1, 7.2, and 7.2 may be adjusted in combination without a total conveying amount of the three spinning pumps being exceeded.

The method according to the invention and the device according to the invention are therefore particularly suitable to produce a mixed color of a composite thread 14 at a high flexibility based on base colors provided.

As an alternative the device illustrated in FIG. 1 may also be operated such that a control program is stored in the controller 8, which has, for example, machine settings comprising two operating points, at which the pump drives 7.1, 7.2, and 7.3 are adjusted in periodic time intervals. In this manner the composite thread 14 may be advantageously produced with a continuous and uniform color pattern. For example, in a first operating mode certain mass ratios of the filament bundles 13.1, 13.2, and 13.3 would be created by means of the adjusted conveyor amounts at the spinning pumps 2.1, 2.2, and 2.3, which result in a first mixed color of the composite thread 14. After resetting to a second operating point, the pump drives 7.1, 7.2, and 7.3 actuated via the controller 8 would result in the respective change of the conveying amount of the polymer melt, thus changing the mass ratio of the filament bundle 13.1, 13.2, and 13.3 created during the extrusion. After bring together the filament bundles 13.1, 13.2, and 13.3 a changed mixed color is therefore achieved in the composite thread 14. The resetting of the operating points could occur in short time intervals such that a pattern formation is possible in the composite thread 14. For this purpose the operating modes may be advantageously stored in the control program of the controller 8 as machine settings, wherein the control program could optionally initiate one, two, or three, or even more machine settings.

For carrying out the method according to the invention a further example embodiment of the device according to the invention is illustrated in FIG. 2. For this purpose only the means for producing the polymer melt are shown. All remaining device parts listed and described herein are identical to the example embodiment according to FIG. 1 such that reference can be made to the above description as follows, and only the differences will be explained.

In the example embodiment illustrated in FIG. 2 the coloring of the polymer melts is carried out outside of the extruder. A plurality of feed units 27.1, 27.2, and 27.3 is provided for the coloring of the polymer melts, which are associated with the melt lines 5.1, 5.2, and 5.3 on the outlet sides of the extruder 1.1, 1.2, and 1.3. The feed units are constructed identically such that the construction at the feed unit 27.1 shall serve as an example of describing all feed units. The feed unit 27.1 has a tank 30.1, to which a dosing pump 28.1 is connected. The dosing pump 28.1 is driven via a dosing drive 29.1. The dosing pump 28.1 is connected to an outlet side on the melt line 5.1. In this manner a liquid dye may be removed from the tank 30.1 via the dosing pump 28.1, and continuously fed to the melt guided in the melt line 5.1. The liquid dye and the polymer melt are subsequently mixed in a mixing unit 26.1 and fed to the spinning pump 2.1.

In this manner one of the feed units 27.1, 27.2, 27.3 and one of the mixing units 26.1, 26.2, and 26.3 is associated with each melt line 5.1, 5.2, and 5.3.

The dosing drives 29.1, 29.2, and 29.3 of the dosing pumps 28.1, 28.2, and 28.3 are mutually coupled to the controller 8 such that individual amounts of dyes may be fed for dying the polymer melts by means of setting the conveyor amounts on the dosing pumps 28.1, 28.2, and 28.3.

In the operating mode a mixed color of a composite thread 12 may therefore be changed easily in that at least one of the dosing drives 29.1 to 29.3 is actuated via the controller 8 for changing the feed amount of the dye. In this manner the drive speed of the dosing pump may be increased or reduced via the dosing drive such that a greater or lower amount of the liquid dye is fed for coloring the polymer melt. This method variation also has the advantage that the change of the production of the polymer melt set during the extrusion has no effect on the spinning yarn count of the filament bundles 13.1, 13.2, and 13.3. The spinning yarn count of the extruded filament strands remain essentially constant as essentially only the visual appearance of the filament strands is changed due to the liquid dye.

FIG. 3 illustrates a further example embodiment, essentially forming a combination of the example embodiments according to FIG. 1 and FIG. 2. The example embodiment illustrated in FIG. 3 also shows only the means for producing the polymer melts such that reference can be made to the previous description of the example embodiment according to FIG. 1.

In the example embodiment illustrated in FIG. 3 the polymer melt is produced by means of an extruder 1. The extruder 1 is connected to the spinnerets 2.1, 2.2, and 2.3 via the melt line 5.1, 5.2, and 5.3. A mixing unit 26.1, 26.2, and 26.3 is disposed inside of each melt line 5.1, 5.2, and 5.3, which interacts with a feed unit 27.1, 27.2, and 27.3. In this manner the partial flows of the polymer melts produced by means of the extruder 1 may be colored using different dyes directly before the extrusion process.

In order to change the mixed color of the composite thread 14 formed by the filament bundles 13.1, 13.2, and 13.3 both the pump drives 7.1, 7.2, and 7.3 of the spinning pumps 2.1 to 2.3 and the dosing drives 29.1, 29.2, and 29.3 of the dosing pumps 28.1 to 28.3 may be changed in terms of their operating settings via the controller 8. The operating settings of the dosing pumps and the operating settings of the spinning pumps may be changed alternatively, or collectively. In this manner maximum flexibility of the visual appearance of a composite thread is achieved by means of color combinations of a plurality of filament bundles.

The method according to the invention and the device according to the invention are therefore particularly suitable to create spun-dyed composite threads and mixed colors. The number of filament bundles and device parts shown in the exemplary embodiments for the extrusion of the filament bundles is exemplary only. The composite thread may also be formed by two, four, or more filament bundles.

### LIST OF REFERENCE SYMBOLS

1, 1.1, 1.2, 1.3 extruder
2.1, 2.2, 2.3 spinning pumps
spinning beam
4.1, 4.2, 4.3 spinneret
5.1, 5.2, 5.3 melt line
6.1, 6.2, 6.3 distribution line
7.1, 7.2, 7.3 pump drive
8 controller
9 microprocessor
10 thread guide
11 treatment unit
12 composite means
13.1, 13.2, 13.3 filament bundle
14 composite thread
15 winding unit
16 spool
17.1, 17.2 spool spindle
18 spindle carrier
19 changing unit
20 crimping unit
21 compression chamber
22 thread plug
23 cooling drum
24 twisting nozzle
25 conveying nozzle
26.1, 26.2, 26.3 mixing unit
27.1, 27.2, 27.3 feed unit
28.1, 28.2, 28.3 dosing pump
29.1, 29.2, 29.3 dosing drive
30.1, 30.2, 30.3 tank

1. A method for producing a multi-color composite thread from a plurality of extruded colored filament bundles, comprising:
producing a plurality of differently dyed polymer melts;
extruding the plurality of differently dyed polymer melts in parallel through a plurality of spinnerets to form the plurality of extruded colored filament bundles;
bringing together the plurality of extruded colored filament bundles to form the multi-color composite thread; and
changing the plurality of differently dyed polymer melts during the extruding to change mixed coloring of the multi-color composite thread.

2. The method according to claim 1,
wherein the multi-color composite thread has a consistent total yarn count, which is of equal count before and after the changing to change mixed coloring of the multi-color composite thread.

3. The method according to claim 1,
further comprising one of increasing and decreasing a conveying amount of at least one of the plurality of differently dyed polymer melts for the extrusion of one of the plurality of extruded colored filament bundles.

4. The method according to claim 3,
wherein the conveying amount of at least one of the plurality of differently dyed polymer melts is a plurality of conveying amounts of the plurality of differently dyed polymer melts that is simultaneously changed in relation to a total conveying amount of all of the plurality of differently dyed polymer melts for the extrusion of all of the plurality of extruded colored filament bundles.

5. The method according to claim 4,
wherein the plurality of conveying amounts of the plurality of differently dyed polymer melts are changed such that the sum of all of the plurality of conveying amounts is equal to the total conveying amount.

6. The method according to claim 1,
further comprising feeding a liquid dye into at least one of the plurality of differently dyed polymer melts;
wherein changing the plurality of differently dyed polymer melts includes one of increasing or reducing an amount of the liquid dye in the feeding.

7. The method according to claim 6,
wherein feeding the liquid dye into at least one of the plurality of differently dyed polymer melts includes feeding a plurality of liquid dyes into all of the plurality of differently dyed polymer melts; and
wherein increasing or reducing the amount of the liquid dye in the feeding includes is-simultaneously changing the amount of the liquid dye in all of the plurality of differently dyed polymer melts.

8. The method according to claim 1,
wherein the production of the plurality of differently dyed polymer melts is repeatedly changed at a predetermined time interval.

9. The method according to claim 8,
wherein the production of the plurality of differently dyed polymer melts is determined by a machine setting, wherein extruding to form the plurality of extruded colored filament bundles includes alternating the machine setting between a first setting and a second setting.

10. A device, comprising:
a plurality of polymer melt producers constructed and arranged to produce a plurality of colored polymer melts;
a plurality of spinnerets constructed and arranged to extrude a plurality of colored filament bundles made from the plurality of colored polymer melts;
a compositor constructed and arranged to bring together the colored filament bundles to form a composite thread in a mixed color; and
a controller coupled to at least one of the polymer melt producers, the controller being constructed and arranged to one of change and set a color mixture of the composite thread when the plurality of spinnerets extrude the plurality of colored filament bundles.

11. The device according to claim 9,
wherein the controller includes a microprocessor constructed and arranged to execute calculation operations to generate a control signal and send the control signal to the at least one of the polymer melt producers while maintaining a total yarn count of the composite thread.

12. The device according to claim 10,
further comprising a plurality of spinning pumps constructed and arranged to convey the colored polymer melts, each of the plurality of spinning pumps being constructed and arranged to be driven independently of each other via a plurality of pump drives, at least one of the plurality of pump drives being coupled to the controller for changing a drive speed.

13. The device according to claim 12,
wherein the plurality of pump drives of the plurality of spinning pumps are collectively connected to the controller such that the a plurality of pump drives may be controlled simultaneously for changing the drive speeds, wherein an amount of the colored polymer melt conveyed by each of the plurality of spinning pumps corresponding to the drive speeds is determined by the controller in terms of a total conveying amount.

14. The device according to one of the claim 10,
further comprising a plurality of feed units constructed and arranged to feed for a plurality of liquid dyes to the plurality of polymer melt producers, the plurality of feed units having a plurality of dosing pumps driven by a plurality of separate dosing drives, and at least one of the plurality of dosing drives being connected to the controller for changing a drive speed.

15. The device according to claim 10,
wherein the controller is constructed and arranged to run at least one control program that directs a plurality of machine settings for the plurality of polymer melt producers to produce the plurality of colored polymer melts in an alternating manner.

16. The device according to one of the claim 10,
wherein the compositor includes at least one crimping unit constructed and arranged to bring together the colored filament bundles to form the composite thread in a crimped manner.

17. The device according to one of the claim 10,
wherein the compositor includes at least one twisting nozzle constructed and arranged to bring together the colored filament bundles to form the composite thread.

18. A multi-colored composite thread, comprising a plurality of colored filament bundles of a mixed color,
wherein the mixed color includes uniform or irregular color changes on the thread.
